(19) United States
(12) Patent Application Publication
(10) Pub. No.: US 2006/0288783 A1
(43) Pub. Date: Dec. 28, 2006

(54) Bearing monitoring system

(75) Inventors: Stephen L. Ricker, Ann Arbor, MI (US); Alexandre Froes, Ann Arbor, MI (US)

Correspondence Address: CROWELL & MORING LLP;INTELLECTUAL PROPERTY GROUP, P.O. BOX 14300, WASHINGTON, DC, 20044-4300, US

(73) Assignee: NSK CORPORATION, Ann Arbor, MI (US)

(21) Appl. No.: 11/440,028

(22) Filed: May 25, 2006

Related U.S. Application Data
(60) Provisional application No. 60/684,217, filed on May 25, 2005.
(60) Provisional application No. 60/700,711, filed on Jul. 20, 2005.

(51) Int. Cl. G01M 13/04

(52) U.S. Cl. 73/593

(57) ABSTRACT

A device and method for monitoring machine components, such as bearings, in which micro-electronic monitoring devices are provided in contact with or within the component to be monitored to acquire and transmit performance data, preferably wirelessly, to a receiving device. The acquired information, which may be accompanied by unique monitoring device identification information, may be further processed and presented to an operator in human-interpretable form. The monitoring data acquisition may be conducted over dedicated communications circuits, or may be conducted, for example, by bringing a suitable receiving device, such as a receiver-equipped PDA, within data transmission range of the monitoring devices.

This application claims priority to U.S. provisional patent application Ser. No. 60/684,217 filed May 25, 2005 and U.S. provisional patent application Ser. No. 60/700,711 filed Jul. 20, 2005, the disclosures of which are expressly incorporated herein by reference.

### BACKGROUND AND SUMMARY OF THE INVENTION

The present invention is directed to monitoring of bearings, and particular to bearing monitoring sensors and bearing performance data acquisition using such sensors.

Although for the purpose of convenience a monitoring device of the present invention is described hereinafter as a bearing monitoring device, the device can be used to monitor the performance of gears, pulleys, sheaves, or any other machine components.

A bearing monitoring device of the present invention collects bearing operating data through a physical connection to the bearing and transmits the collected data to a receiver or transceiver, fault detector, PDA, and/or CPU preferably without a physical connection to the receiving component. Compared with prior art devices, the device of the present invention can be small and can be of low cost and low power usage.

The use of the bearing monitoring device provides several advantages. For example, the device allows monitoring of bearing performance and advanced warning of bearing failure. For anther example, the bearing performance data from the device can be used to optimize or verify operating conditions or bearing design. Therefore, the device can be used during bearing operation or in the design and development of a bearing or other machine components.

A bearing monitoring device of the present invention may include one or more of these components: an accelerometer (preferably a 3-axis accelerometer), a temperature sensor and a strain (and/or load) sensor or analyzer. Other suitable components may also be incorporated in the device, such as sensors that measures noise levels and the presence or absence of a chemical, gas and/or liquid. The components of the device may be of the piezoelectric type or any type that is suitable for the purpose.

The accelerometer can measure dynamic accelerations (e.g., vibrations). Preferably, the accelerometer is a 3-axis accelerometer, although it can also be a one-axis or two axis accelerometer.

The temperature sensor can measure current bearing temperature and/or changes in bearing temperature over a given period of time.

The strain (and/or load) sensor or analyzer can measure current stresses/loads of the bearing or a portion of the bearing, and/or stresses/loads over a given period of time. In a preferred embodiment of the present invention, the strain in the inner ring of a bearing is monitored during bearing installation to determine when the proper strain is reached which indicates proper mounting. The information is collected by the strain sensor as analog data which is translated into digital data by the embodiment.

The bearing monitoring device can have a unique permanent identification code, such as an identification number, which is transmitted with the collected data. In the preferred embodiment discussed above, the identification code is digital and is transmitted with the translated digital data. This code is permanently stored within the device and is used to identify the device each time the collected data is sent. This code can be associated with information such as a bearing code, an installation date, and maintenance records with the use of software in or connected to the receiving device. This information may be stored in the device of the present invention or in a component that received the data from the device with the use of software.

Other objects, advantages and novel features of the present invention will become apparent from the following detailed description of the invention when considered in conjunction with the accompanying drawings.

### BRIEF DESCRIPTION OF THE DRAWINGS

FIGS. 1a and 1b show example bearing monitoring device mounting locations in accordance with embodiments of the present invention.

FIG. 2 shows a bearing monitoring device installation locations in accordance with a further embodiment of the present invention.

FIG. 3 shows a schematic diagram of a bearing monitoring data acquisition and transmission system employing wireless communications in accordance with another embodiment of the present invention.

FIG. 4 shows a schematic illustration of a remotely-accessible bearing monitoring data acquisition and transmission system in accordance with another embodiment of the present invention.

### DETAILED DESCRIPTION

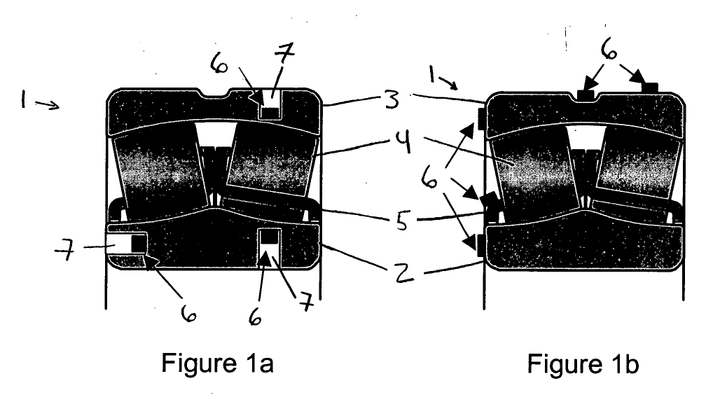

FIGS. 1a and 1b illustrate cross-section views of bearings 1 to show example bearing monitoring device mounting locations. The bearings include inner race 2 and outer race 3, with rolling elements 4 and bearing retainer cage elements 5 therebetween. The bearing monitoring device 6 preferably is physically connected to or embedded in the bearing. It can be installed on the bearing during bearing production or after bearing production, such as when the bearing is being installed. The device can be installed at any suitable location on a bearing, such as in a inner ring, a outer ring, a rolling element, or a cage. As illustrated in FIG. 1a, bearing monitoring devices 6 may be installed in recesses 7 provided during production of the bearing races. FIG. 1b shows alternative surface mounting locations for bearings not provided with mounting recesses during production, such as in-service bearings being retrofitted with bearing monitoring devices.

The bearing monitoring device 6 is small, preferably between 1 mm×1 mm×0.2 mm to 10 mm×10 mm×3.5 mm, more preferably at 10 mm×10 mm×1 mm. The weight of the device is preferably between 0.01 to 2 grams. The current usage is low, preferably less than 1 mA, more preferably less than 0.6 mA. The power used by the bearing monitoring device may be provided by a battery on the device, but preferably is generated through the use of radio frequency identification (radio frequency linking) and/or magnetic impulses. The use of piezoelectric components (i.e. accelerometer, temperature monitor, stress/load analyzer, etc.) allows small power consumption.

It is highly desirable that the bearing monitoring device can endure the conditions under which the bearing operates over the expected life of the bearing. These conditions include, but are not limited to, temperature variations, chemical and moisture exposure, shock loading, and vibration.

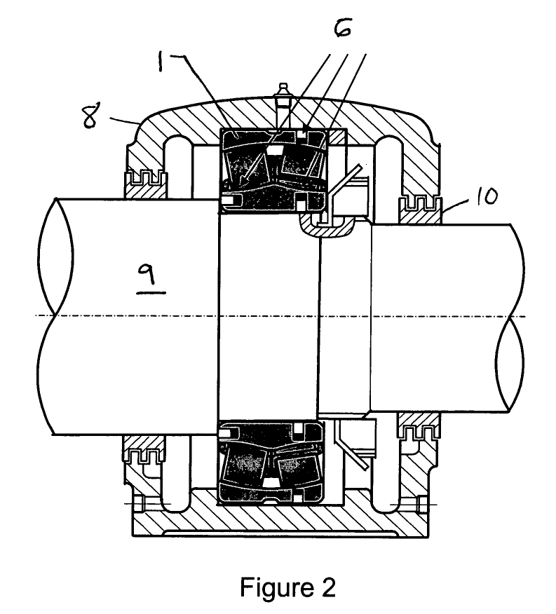

In FIG. 2, the bearing 1 from FIG. 1a is shown mounted in an object, in this case a bearing carrier 8 (also referred to as simply a “bearing”), with a shaft 9, with bearing-to-shaft seal elements 10. The object can be made from any suitable materials, such as cast iron, cast steel, cast aluminum.

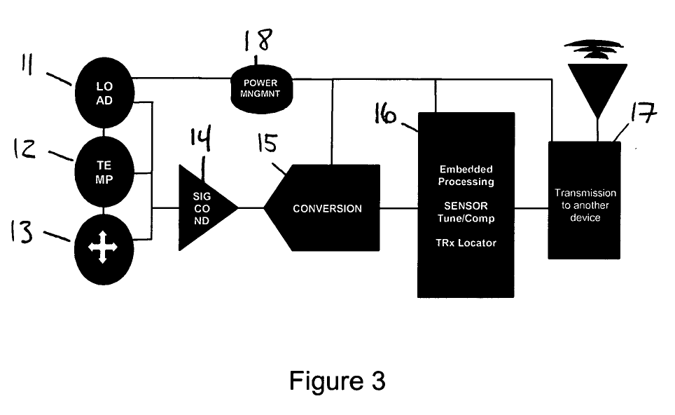

Preferably, the bearing monitoring device can transmit wirelessly data through objects in which the bearing is mounted and at a distance of at least 15 meters away from the receiving device. FIG. 3 schematically illustrates an example of an arrangement of components of a bearing monitoring device for use with a wireless transmission system, in which load sensor 11, temperature sensor 12 and accelerometer 13 provide sensor output signals to a signal conditioner 14. Conditioned signals outputted from signal conditioner 14 are passed to a signal conversion unit 15 which provides analog-to-digital signal conversion, and the digital signals output from conversion unit 15 are provided to an embedded processing microcircuit 16 within the bearing monitoring device. Following any desired processing of the digital signals (such as application of sensor compensation corrections), the processed signals, along with any other desired information, such as a monitoring device-unique identifier, are passed to an low-power RF transmitter 17 for transmission to a remote receiving device. Alternative transmission approaches may be employed in lieu of, or in addition to, radio frequency transmission, such as ultrasonic communication through the component structure. The bearing monitoring device in this embodiment also includes a power management module which controls distribution of electrical energy to the bearing monitoring device components.

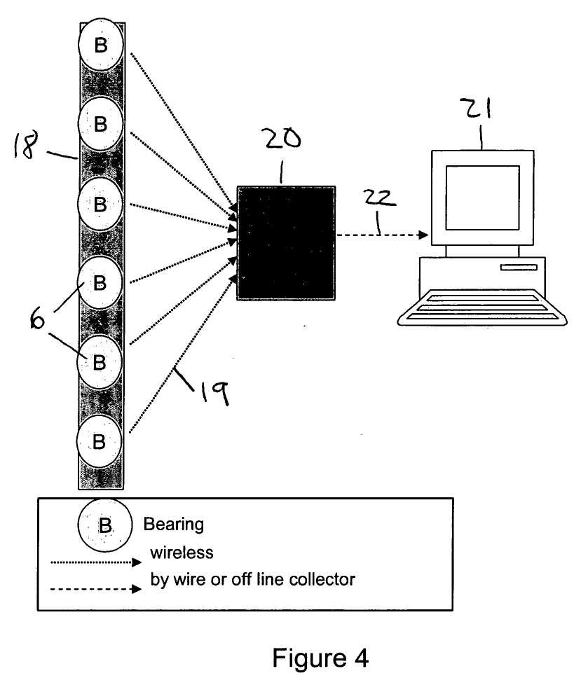

As shown in FIG. 4, information from one or more bearing monitoring devices 6 monitoring one or more bearings in a piece of equipment 18, may be received over wireless links 19 by a receiving device 20. Receiving device 20 in this embodiment is a separate data gathering device which obtains bearing monitoring information from bearing monitoring devices 6 and transmits the accumulated information to a computing device 21 (in this embodiment, a desktop computer) over communications link 22. Communications link 22 may be, for example, a dedicated wireless or “wired” (e.g., metal conductor, optical fiber, etc.) communications link, or a temporarily-established connection. Alternatively, the receiving device may be integrated with the computing device. However embodied, the computing device includes programming which processes the received digital information, and presents the monitored bearing information in a human-interpretable format. The receiving device may include a transceiver, fault detector, and/or CPU which in turn processes the information. The receiving device 20 may be, for example, a suitably-equipped PDA (personal digital assistant) which is carried by an operator or a device to a position near the monitored bearing(s) (i.e., within the transmitting range of the bearing monitoring device) for data acquisition. Suitable software to program a portable or desktop computing device may be installed at the end user's computer or provided over the Internet.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A monitoring system for monitoring physical parameters of a component, comprising:
a monitoring device adapted to be mounted in contact with the component, said monitoring device including:
at least one sensor for detecting at least one physical parameter of the monitored component,
a signal processing circuit for processing signals generated by the at least one sensor into monitored parameter information,
a transmitter for transmitting the monitored parameter information outside the monitoring device, and
an electric power source;
a receiver located remote from the monitoring device for receiving the monitored parameter information; and
an interface unit programmed to present the monitored parameter information in operator-readable form.

2. The monitoring system of claim 1, wherein the monitored component is a bearing.

3. The monitoring system of claim 2, wherein the at least one sensor includes at least one of an accelerometer, a temperature sensor and a strain sensor.

4. The monitoring system of claim 1, wherein the transmitter is one of an RF transmitter and an ultrasonic transmitter.

5. The monitoring system of claim 3, wherein the transmitter is one of an RF transmitter and an ultrasonic transmitter.

6. The monitoring system of claim 1, wherein the transmitter is configured to transmit device-unique identification information with the transmitted parameter information

7. The monitoring system of claim 3, wherein the transmitter is configured to transmit device-unique identification information with the transmitted parameter information

8. The monitoring system of claim 5, wherein the transmitter is configured to transmit device-unique identification information with the transmitted parameter information

9. The monitoring system of claim 1, wherein the receiver is a portable data acquisition device.

10. The monitoring system of claim 8, wherein the receiver is a portable data acquisition device.

11. The monitoring system of claim 10, wherein the portable data acquisition device is a PDA.

12. A monitoring device for monitoring physical parameters of a component and adapted to be mounted in contact with the component, said monitoring device, comprising:
at least one sensor for detecting at least one physical parameter of the monitored component;
a signal processing circuit for processing signals generated by the at least one sensor into monitored parameter information;
a transmitter for transmitting the monitored parameter information outside the monitoring device; and
an electric power source.

13. The monitoring device of claim 12, wherein the monitoring device is a bearing monitoring device.

14. The monitoring system of claim 13, wherein the at least one sensor includes at least one of an accelerometer, a temperature sensor and a strain sensor.

15. The monitoring system of claim 12, wherein the transmitter is one of an RF transmitter and an ultrasonic transmitter.

16. The monitoring system of claim 14, wherein the transmitter is one of an RF transmitter and an ultrasonic transmitter.

17. The monitoring system of claim 12, wherein the transmitter is configured to transmit a device-unique identification information with the transmitted parameter information

18. The monitoring system of claim 14, wherein the transmitter is configured to transmit device-unique identification information with the transmitted parameter information

19. The monitoring system of claim 16, wherein the transmitter is configured to transmit device-unique identification information with the transmitted parameter information

20. A method of monitoring physical parameters of a component, comprising the steps of:
locating a monitoring device in contact with the component, said monitoring device including:
at least one sensor for detecting at least one physical parameter of the monitored component,
a signal processing circuit for processing signals generated by the at least one sensor into monitored parameter information,
a transmitter for transmitting the monitored parameter information outside the monitoring device, and
an electric power source;
monitoring the at least one physical parameter with the monitoring device;
transmitting the monitored parameter information outside the monitoring device;
receiving with a receiver located remote from the monitoring device the monitored parameter information; and
presenting via an interface unit the monitored parameter information in operator-readable form.

21. The monitoring method of claim 20, wherein the monitored component is a bearing.

22. The monitoring method of claim 21, wherein the at least one sensor includes at least one of an accelerometer, a temperature sensor and a strain sensor.

23. The monitoring method of claim 23, wherein the transmitter is one of an RF transmitter and an ultrasonic transmitter.

24. The monitoring method of claim 23, wherein the transmitter transmits device-unique identification information with the transmitted parameter information

25. The monitoring method of claim 24, wherein the receiver is a portable data acquisition device.

26. The monitoring method of claim 25, wherein the portable data acquisition device is a PDA.
